(19) United States
(12) Patent Application Publication
(10) Pub. No.: US 2008/0221871 A1
(43) Pub. Date: Sep. 11, 2008

(54) HUMAN/MACHINE INTERFACE

(75) Inventor: David Braben, Cambridge (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Frontier Developments Limited, Cambridge (GB)

(21) Appl. No.: 12/033,536

(22) Filed: Feb. 19, 2008

(30) Foreign Application Priority Data
Mar. 8, 2007 (GB) 0704492.8

(51) Int. Cl. G06F 17/27; G06F 3/048

(52) U.S. Cl. 704/9; 715/810; 715/822; 704/E13.002

(57) ABSTRACT

A method to allow a user to cause a machine to make an utterance, together with apparatus for obtaining input from a user. The method comprises the steps of: analysing the context within which the utterance is to be made; creating a list of utterances appropriate to the context; on a human/machine interface, creating an indication that identifies to the user those utterances that are available, and allowing the user to indicate one of those utterances; and causing an utterance indicated by the user to be made. The apparatus comprises: a visual display configured to display a plurality of indicia angularly spaced on a locus about an origin, each of the plurality of indicia corresponding to a respective option; and an input device for use in indicating an angular position, wherein the apparatus is configured to generate an input event corresponding to an option associated with one of the plurality of indicia at an angular position corresponding to an angular position indicated by the input device.

This invention relates to human/machine interface methods and implementations. It has particular, but not exclusive, application to an interface that allows a user to control conversational interaction with a character or characters in a computer game. It also has application when, for some other reason, the speaker is prevented from talking (for example due to a disability), or on mobile devices where speech is undesirable due to background noise or secrecy or bandwidth cost.

Getting conversations to work in a rich, natural way in games is a difficult task. There is a plethora of possible topics for discussion, and the potential response sequences to each are even more numerous. Most instances of conversational character interaction in games to date are therefore very simplistic, stop the action while dialogue takes place, and rely on a simple dialogue tree which in most instances could correspond with a yes/no answer.

An aim of this invention is to provide an interface to allow natural two-way interaction, that can occur in parallel with other game action, without requiring the user to talk themselves (although, embodiments of the invention do allow for that, with speech recognition software to understand which option the player was selecting or what the player was saying).

The interface allows a user to select from one or more utterances that can be made, the utterances being selected in a context-sensitive manner (or to opt to make no utterance). Thus, in a game, the utterances will be varied in response the disposition of a player's character and the disposition of other characters, objects and so forth within the game. Note that the term “utterance” in the context of this specification does not necessarily imply any sound production in the real world—for example, a game player may turn off sound to play in silence to avoid disturbing others. It may be that the utterance only has virtual existence within the virtual world of a game.

From a first aspect, the invention provides a method to allow a user to cause a machine to make an utterance, comprising: (a) analysing the context within which the utterance is to be made; (b) creating a list of utterances appropriate to the context; (c) on a human/machine interface, creating an indication that identifies to the user those utterances that are available, and allowing the user to indicate one of those utterances; and (d) causing an utterance indicated by the user to be made.

From a second aspect, the invention provides a software component that can be executed on a hardware platform to perform a method according to the first aspect of the invention.

The options that are presented to a user can be thought of as corresponding to the thoughts that a character may have on his or her mind to say, and the player's action in selecting one of them is effectively making the character's mind up.

In one embodiment, utterances are selected from a range of alternatives that might be applicable for the context. For example, each utterance may be applied a score according to its applicability to the context, and only those utterances that exceed a threshold score are entered into the list of utterances created in step (b). In this way, the present invention is able to reduce what would otherwise be an unmanageable list of options.

In a further embodiment, the context is definable (or further definable) by one or more parameters selectable by a user. In this way, a user is able to influence the list of indications presented. For example, the method may further comprise providing a user with an electronic notebook for storing conceptual items for use in influencing the indications presented. The electronic notebook may be updatable by a user (e.g. to add conceptual items from previous conversations or events).

A system to which the invention relates must allow a user to select from a plurality of optional utterances quickly and accurately. In the case of a game, a delay in making a selection or making an incorrect selection may harm the player's position in the game and reduce their satisfaction with it. Obtaining fast, accurate input is a problem that pervades computing. In the case of computer systems that interact with the real world, erroneous or untimely input could result in financial loss or physical harm.

From a third aspect, the invention provides apparatus for obtaining input from a user, comprising: a visual display configured to display a plurality of indicia angularly spaced on a locus about an origin, each of the plurality of indicia corresponding to a respective option; and an input device for use in indicating an angular position, wherein the apparatus is configured to generate an input event corresponding to an option associated with one of the plurality of indicia in response to an angular position indicated by the input device.

This apparatus has particular application to situations in which the input device that is spatial in nature, such as a game controller or a joystick. In this way, a user can make a selection by moving a component of the input device in a particular direction. For example, in one embodiment the user can make a selection by pivoting or rotating a component of the input device.

From a fourth aspect, the invention provides a system for obtaining input from a user, the system including: apparatus that includes a visual display and an input device, in which the input device can be used to indicate an angular position; and a method comprising displaying a plurality of indicia, each corresponding to a respective option, angularly spaced on a locus about an origin; and upon use of the input device to indicate an angular position, generating an input event that corresponds to the respective option associated with one of the indicia at an angular position corresponding to the angular position indicated by the input device.

An embodiment of the invention will now be described in detail, by way of example, and with reference to the accompanying drawings, in which:

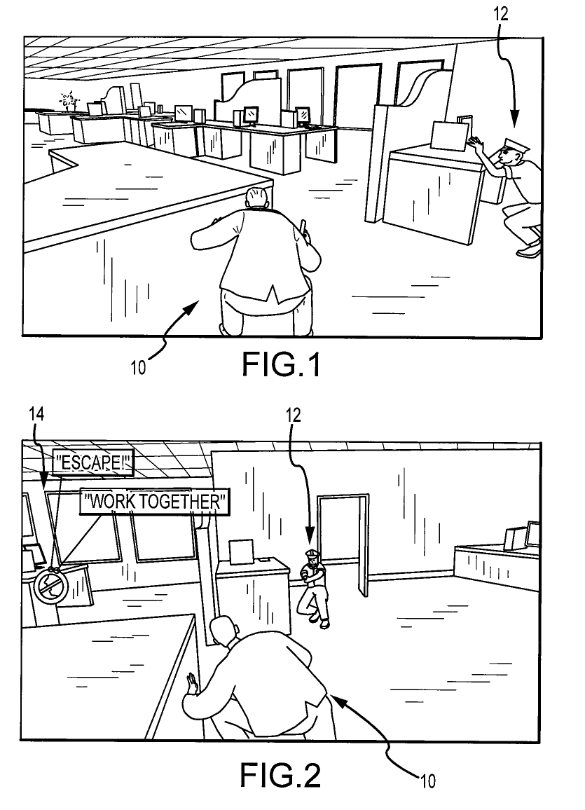

FIGS. 1 and 2 are screenshots from a game that incorporates a first embodiment of the invention; and

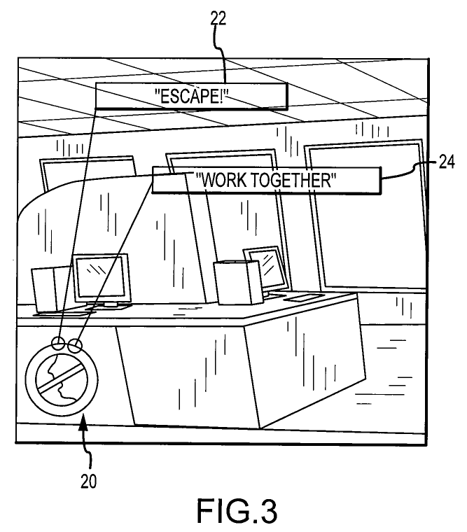

FIG. 3 shows, at a larger scale, detail from FIG. 2.

Although the embodiment is described for use in a game, this is not a limitation of the invention; this application is described for convenience only.

This embodiment is applied to the control of any computer or “video” game (e.g. without limitation, an action game, adventure game or role-playing game). The game is implemented in software that is executable upon a hardware platform that has user input controls such as a keyboard or game controller, and output controls such as a computer graphics interface and a sound-generating interface.

The player is represented in the virtual world of the game by a character. The display presented to the player is approximately the view that would be seen by a camera following the player through the virtual world—a so-called “third-person view”. However, the invention would have equal applicability to any game in which the player is presented with any other view of a scene, including without limitation the view that would be seen ‘through the eyes of’ the character—a so-called “first-person view”. Thus, there is a “camera position” that follows the player through the virtual world. The player's character can interact with other characters in the virtual world, these being controlled by game-playing logic or other human players. These other players will be referred to as ‘non-player characters’ (abbreviated to NPC) in the specification.

This embodiment implements a method of using game context, camera position and camera direction, and user behaviour to allow rapid conversational interaction that means the other game action does not need to stop. This facilitates in-game conversational exchanges in circumstances where it would not otherwise be practical—for example during a gun fight, or while running from (or after) other characters.

In a game setting, a player character has many attributes that affect the way that character is perceived. For example, if they are running (as opposed to walking), carrying a gun openly, bleeding profusely, dressed in a way that seems incongruous (a suit in a slum, swimming costume in an office, chicken suit in a factory), just dialled a number on a telephone, then this is part of a context in which they might want to speak. Similarly, where they are looking (determined here by the way the camera is looking, which is, directly or indirectly, under control of the player), and any objects or NPCs that fall within a central zone of this view, are also a significant part of this context. For instance, it can be assumed that the player either wants to talk (or shout or whisper) to or about such central NPCs. In turn, the appearance and current or recent actions of NPC(s) in the view, including what, if anything, they have said in the recent past, also affects the context, as does the overall setting and any wider objectives the player elects to impose or has imposed on them within the game.

The embodiment is about using this context, and the context of what queries make sense in the overall game world and story, to make available to the user the most relevant responses in a practical way.

In the game setting, the user (i.e., the player) can operate a control, such as a push-button, to invoke a conversation interface to say something at any time in a game, or the conversation interface can be triggered by the game itself. When the conversation interface is invoked, the system first gathers the context from the following sources:
1. Character status. Examples of parameters that define the character's status include clothing, health, crimes committed, visible injury, current rate of movement.
2. Current local conditions. Examples include noise level, lighting level, danger level (is it safe to remain?).
3. Recent history: how the player arrived here. For example, whether the player is legally present, and to whom this presence is known; any reputation that precedes the player; what has been said by other characters in the immediate past.
4. NPCs currently present: what these characters are known to know about the player;

what the player is known to know about these NPCs.
5. Camera setting: which way it is pointing; what (and who) is visible in the scene. (The player can usually exert independent control of the camera beyond the automatic movement of the camera to follow the player's actions with the character.)
6. Previously spoken dialogue. This is to provide the ability to resume conversations after an interruption, and to ensure that an already taken option is not repeated.
7. Special context. If some significant event has just happened or is still happening.

Then, the system processes the possible responses based on this context:
1. For each NPC around the player's character, a script (that is, executable or interpretable computer code) is triggered. This script interrogates the current behaviour, location and appearance of that NPC, and provides to the conversation interface a list of things that the player might want to say relating to that NPC together with a numeric value that indicates the importance or relevance of that response with respect to the player in the current context.
2. For each piece of speech within recent time that has been made by an NPC within the local area, a script is run for that NPC to provide the player with sensible replies or other elements. These replies are also scored, based on their relevance in the current context. Note that the speech made by an NPC may not have been to the player but to another NPC, and this gives rise to the possibility of the player “butting in” and for eavesdropping a conversation to which they are not a party.
3. For the player, a script is run for each plausible order or specific statement the player might want to make unilaterally, or ‘to the world’. This would include general questions to a room full of people, or a shouted utterance, such as “Get down!” to a crowd, or other phrases relevant to wider objectives the player may currently have.
4. All these options are then aggregated, and amalgamated as applicable. The top-scoring responses that exceed a certain variable threshold are then presented to the user via the user interface (for example, as a display of text) as options for the player to select. This variable threshold may be dependent on the tension of the current situation (i.e., it may itself be contextual). The mood of each response can be indicated on the interface; for example by colouring the background of the text, or with another form of highlight.
5. The player can then select one of the displayed utterances and the character begins to speak it.

When the player speaks, this information is passed back to the scripts controlling the NPCs within earshot, and their scripts can make their character respond accordingly. The information is passed including time offsets for any key parts, if there are any, of the message. For example NCPs may respond to the fact of the player's character speaking immediately (as it may have given away their position), or to a name or threat that is included within the speech after a specific time offset (to simulate the receipt of information as the player speaks rather than otherwise). Note: this happens to all NPCs within earshot, even if speech was not addressed at them, or their presence is not known to the player. They may act on this information, or interrupt the speech, in the same way the player can.

Consider now how this may be introduced into a game. In the scenario of the game, a player's character, a fugitive, encounters a police officer.

This example shows how a specific scene in a game is processed, and the resultant outcomes. Here, the player, controlling a character called ‘Jameson’. He has previously been accused of killing a deeply disliked but powerful politician, something he did not do, and has broken into a building to obtain some evidence of the true assailant. Nevertheless, at this point the press believe Jameson did do it, and such stories have been carried in the media, so most people therefore, also believe Jameson is guilty. He will be recognised from his pictures on TV. Here, the player has chosen to go into this building undisguised.

The scenario then proceeds to that shown in FIG. 1. Immediately prior to this point, Jameson 10, gun drawn, has encountered a police officer 12 (an NPC), also with his gun drawn. The officer recognized Jameson, and ordered him to put his gun down. Jameson was conciliatory, but at this point unseen masked individuals 14 started shooting at both Jameson 10 and the cop 12 with automatic weapons. The police officer announces himself to the other NPCs—to a further hail of gunfire. Both parties are now pinned down.

The player turns his character 10 to face the police officer 12 and presses the ‘talk’ button to initiate a conversation within the game.

The first action performed by the game logic is to gather context. Items that contribute to the context can be summarised as follows:
Jameson is 95% recognizable to other characters in the game.
The environment is noisy because of the nearby gunfire, therefore the mood is tense and dangerous
Jameson is here illegally. TV's presentation of Jameson is as a probable assassin.
Currently present NPCs: the police officer and three armed assailants (unidentified).
The camera shows the police officer in the central zone.
The police officer has told Jameson to put his gun down. This is a recent utterance.
Jameson has been conciliatory to the police officer. This is also a recent utterance.
Jameson and the police officer are under fire and pinned down.

The next action of the game logic is to prepare utterances that a player may wish to make in the context in which he finds himself. Different NPCs are likely to be the targets of different utterances depending upon their status within the game.

Thus, there is created a list of possible things the player might say to each NPC, and these are each associated with a score:

| Target | Utterance | Score |
|---|---|---|
| Police | “I'm innocent” | Medium |
| officer | “Escape! I'll cover you” | High |
| | “Tell them to stop shooting” | Low (unlikely to comply) |
| | (In reply to “drop your weapon”) | High |
| | “Let's work together” | |
| Unidentified | “PUT YOUR WEAPONS | Low (camera direction) |
| assailants | DOWN” (shouted) | |
| | “STOP SHOOTING AND I'LL | Low (camera direction) |
| | GIVE UP” | |

The game playing logic may also generate general statements, but none applies in this context.

A list of options to be presented to the player is then constructed. These are all of the possibilities listed above that exceed a threshold score. Because the context is one of high tension, the threshold is set fairly high. This gives rise to a list as follows:

“Escape: I'll cover you”
“Let's work together”

Each response may have an associated abbreviated text, for use in an input widget 14 that is now generated, as will be described below.

With reference to FIG. 3, when a player is given the opportunity to make an utterance within the virtual world of the game, an input widget 14 is created and overlaid upon the camera display of the game environment. The input widget 14 includes an icon 20 that indicates that it allows a player to cause his or her character to speak within the game. Associated with the icon 20 is a respective text box 22, 24, associated with each utterance that can be made by the character. The text within each box 22, 24 is the abbreviated text to allow a player to read the options available quickly. The player can then use game-playing controls (such as selector push-buttons) to select one of the text boxes (for example, by scrolling through them), and then indicate their selection to the game-playing logic (for example, by pressing a confirmation push-button).

As can be seen from FIG. 3, the text boxes 22, 24 are disposed in the widget 14 in an angular disposition around the icon 20. Further boxes can be displayed, angularly spaced around the icon in a substantially circular locus. As an alternative to scrolling through the text boxes, the user is offered a potentially faster method. This applies where the game is being controlled by a device such as a game controller or joystick that can indicate an angular position, for example by twisting a handle, or moving a handle in a particular direction from a central position. If the user wants to select the topmost text box 22, he/she moves the joystick control in a forward “12 O'clock” direction. To select the next rightmost text box 24, the user moves the joystick in a “1 O'clock” direction. Once the intended text box is selected, the user presses a designated button to select it. This type of interaction is natural for a user who is used to controlling directional movement within a game using a game controller. The input method may make use of other input devices that are adapted to generate an angular input, such as a rotary encoder.

Note that the action of the game continues while the widget 14 is being displayed. If the player does not select an utterance, the widget will cease to be displayed once the context changes and it ceases to be relevant.

Assume that, in this case, the player selects “Let's work together”. The game will then proceed as follows.

The context is now updated, using the same principles as described above. However, the key information in “Let's work together” is not added to the context until roughly midway through the word “together” is uttered (that is, sometime after the player has selected it), this being the time at which the key piece of information in the sentence can be understood by the NPCs, and in particular, the police officer NPC. Whenever the context changes, all NPC scripts are triggered to alert them to this new information.

The script associated with the police officer ‘scores’ the behaviour of the player against other options available. Each action that the police officer might take is considered separately. This works hierarchically: scripts that assess the police officer's opinion of his exit routes, his chance of dying where he is, his current ‘panic factor’, for each of the other characters present whether he believes they intend to kill him, all feed in to higher level scripts that score each option available to him. To these options, responding to Jameson is added. In this case agreeing (temporarily) to work with Jameson is the highest scoring option.

The police officer then proceeds to help the player, laying down covering fire.

Changing the context, even subtly, will change the potential options available and the priorities given to them. So in the previous example, had the player been looking down the room at the attackers instead of at the police officer, the prioritised options would have changed to:

“PUT YOUR WEAPONS DOWN”
“STOP SHOOTING AND I'LL GIVE UP”

as a result of the change in the camera angle.

Had the player selected “PUT YOUR WEAPONS DOWN”, the assailant NPCs are unlikely to respond in the positive. However, even though the statement was not addressed to the police officer NPC, it will be processed by that character's script, and it may, therefore, influence that character's behaviour. For example, the police officer NPC may, as a result, respond by also shouting to the assailants “M.P.D. PUT YOUR WEAPONS DOWN!”, effectively backing Jameson up.

In addition to the effect that the selected utterance has within the virtual world of the game, the utterance may also made audible to the user using sound reproducing hardware of the platform on which the game is executing. Thus, there may be a respective recorded sound data set associated with each utterance. Alternatively, a text-to-speech system may be used to generate audio output from the text of any utterance.

The invention may be used in a device to aid a user who cannot talk. This has many potential applications such as an assistant to a user with motor neuron disease or another disabling illness; a text interface on a data device such as a mobile telephone; or a character interface in a computer game. Conceptual items may be placed ‘on your mind’ by the context of a real or virtual environment, each corresponding to a respective utterance. These are shown symbolically to the user on part of the display. The user may adjust or select other conceptual items from previous conversations or events (for example selecting an electronic notebook may make available other ‘conceptual items’ stored there). Then, in order to construct a reply, the user can select these conceptual items alone or in unison, and the device can then generate and offer up the small number of possible responses that make sense of these items in the current context. This greatly reduces the number of key presses required, and means the device can be used at speeds comparable to or faster than human speech.

1. A method to allow a user to cause a machine to make an utterance, comprising:
(a) analysing the context within which the utterance is to be made;
(b) creating a list of utterances appropriate to the context;
(c) on a human/machine interface, creating an indication that identifies to the user those utterances that are available, and allowing the user to indicate one of those utterances; and
(d) causing an utterance indicated by the user to be made.

2. A method according to claim 1 in which the utterance is made in a virtual world.

3. A method according to claim 2 in which the utterance is made by a virtual character and can be perceived by one or more other virtual characters.

4. A method according to claim 3 in which the context is defined by one or more of the status of the virtual character; current local conditions in the virtual world in the vicinity of the virtual character; and the recent history of the virtual character.

5. A method according to claim 3 in which the context is defined by the status of one or more non-player characters within the virtual world.

6. A method according to claim 3 in which, upon an utterance being made, a respective script is executed for each character within the virtual world that can perceive the utterance.

7. A method according to claim 6 in which each script can modify the behaviour of the respective character in response to the utterance.

8. A method according to claim 1 in which the context is definable or further definable by one or more parameters selectable by a user.

9. A method according to claim 8, further comprising providing a user with an electronic repository for storing conceptual items for use in influencing the indications presented.

10. A method according to claim 1 in which the indications displayed to the user comprise text that indicates the content of the corresponding utterance.

11. A method according to claim 10 in which the text is an abbreviated version of the utterance.

12. A method according to claim 1 in which utterances are selected from a range of alternatives that might be applicable for the context, each utterance is applied a score according to its applicability to the context, and only those utterances that exceed a threshold score are entered into the list of utterances created in step (b).

13. A method according to claim 12 in which the threshold is set as a function of the context.

14. A method according to claim 1 in which, in step (d), the utterance is reproduced on audio reproduction hardware.

15. A method according to claim 1 performed by a software component executing on a hardware platform.

16. A software component that can be executed on a hardware platform to perform a method according to claim 1.

17. A software component according to claim 16 that can be executed on a hardware platform that includes a game-playing console.

18. A software component according to claim 16 that can be executed on a hardware platform that includes a general-purpose computer.

19. A software component according to claim 16 that can be executed on a mobile device such as a mobile telephone or a personal digital assistant.

20. Apparatus for obtaining input from a user, comprising:
a visual display configured to display a plurality of indicia angularly spaced on a locus about an origin, each of the plurality of indicia corresponding to a respective option; and
an input device for use in indicating an angular position, wherein the apparatus is configured to generate an input event corresponding to an option associated with one of the plurality of indicia at an angular position corresponding to an angular position indicated by the input device.

21. Apparatus according to claim 20 in which the angular position indicated by the input device is configured to designate one of the plurality of indicia and the input device is further configured to allow selection of the designated one of the plurality of indicia to generate the corresponding input event.

22. Apparatus according to claim 20 in which the locus is a curve.

23. Apparatus according to claim 22 in which the locus is substantially circular.

24. Apparatus according to claim 20 in which the input device comprises a moveable part and the angular position indicated by the input device is dependent upon a direction in which the moveable part is moved.

25. A system for obtaining input from a user, the system including:
apparatus that includes a visual display and an input device, in which the input device can be used to indicate an angular position; and
a method comprising displaying a plurality of indicia, each corresponding to a respective option, angularly spaced on a locus about an origin; and upon use of the input device to indicate an angular position, generating an input event that corresponds to the respective option associated with one of the indicia at an angular position corresponding to the angular position indicated by the input device.

26. A system according to claim 25 in which the input device is further configured to indicate making a selection; and the method further comprises: highlighting one of the indicia at an angular position corresponding to the angular position indicated by the input device, and generating the input event upon use of the input device to make a selection of the highlighted indicia.

27. A system according to claim 25 in which the locus is a curve.

28. A system according to claim 27 in which the locus is substantially circular.

29. A system according to claims 25 in which the input device comprises a moveable part and the angular position indicated by the input device is dependent upon a direction in which the moveable part is moved.
